(19) United States
(12) Patent Application Publication
(10) Pub. No.: US 2016/0321401 A1
(43) Pub. Date: Nov. 3, 2016

(54) SYSTEM AND METHOD FOR TOPIC-RELATED DETECTION OF THE EMOTIONAL STATE OF A PERSON

(71) Applicant: KONINKLIJKE PHILIPS N.V., Eindhoven (NL)

(72) Inventors: Vincentius Paulus BUIL, Gennep (NL); Joris Hendrik JANSSEN, Eindhoven (NL); Gijs GELEIJNSE, Geldrop (NL)

(73) Assignee: Koninklijke Philips N.V., Eindhoven (NL)

(21) Appl. No.: 15/105,601

(22) PCT Filed: Dec. 19, 2014
(86) PCT No.: PCT/EP2014/078624

§ 371 Date: Jun. 17, 2016

(30) Foreign Application Priority Data
Dec. 19, 2013 (EP) 13198461.9

(51) Int. Cl. G06F 19/00; H04L 29/06

(52) U.S. Cl. CPC G06F 19/322; G06F 19/3418; G06F 19/328; G06F 19/3406; H04L 63/08

(57) ABSTRACT

The present invention relates to a system and method for unobtrusive topic-related detection of the emotional state of a person, in particular of a patient's concerns. In order to provide a user with information about the persons emotional state of a current topic in an unobtrusive way at the right time the system comprises a data recorder (10) for recording person-related data, a data analyzer (20) for analyzing said person-related data to detect, at a given moment, the emotional state of the person and a topic dealt with by the person at the given moment, a topic representing a subject of conversation, a storage unit (30), a retrieval unit (40) for accessing said storage unit i) to check if it comprises an entry for a current topic that the person currently deals with and retrieve a stored emotional state of the person for the current topic and/or ii) to retrieve one or more topics, for which the storage unit comprises entries for the person with respect to one or more predetermined emotional states, and a user interface (50) for outputting the result.

### FIELD OF THE INVENTION

The present invention relates to a system and method for topic-related detection of the emotional state of a person. Further, the present invention relates to a processor and a processor for topic-related detection of the emotional state of a person. Still further, the present invention relates to a computer program for implementing said processing method.

### BACKGROUND OF THE INVENTION

The Philips Hospital to Home offering, as currently e.g. described at http://www.healthcare.philips.com/us_en/clinicalspecialities/cardiology/cardiology_hospitaltohome.wpd, encompasses a number of service-device combinations (e.g. Patient Telemonitoring Services (PTS), Lifeline) with inter-personal care services (e.g. home nurse visits, video calls with health coach). Such combinations of services enable the healthcare organization to optimize care delivery for chronically ill patients, as costly readmissions are avoided or shortened by strengthening at-home care.

To serve the needs of the patient and optimize financial performance, the selection of services should match the patient's current situation. As the patients have progressive diseases and their social situation may change, the arrangement of the services should be revisited on a regular basis.

The assessment of patient needs is typically done through interactions between the healthcare professional/provider (HCP) and the patient and/or an informal caregiver (e.g. a family member of the patient). The topics (for instance care needs) identified during such interaction will reflect the patient with possible care needs, but can be expressed by a third person such as the informal caregiver. However, it is generally a cumbersome process to match insights gathered from a patient interaction with an actionable plan. It requires insights in the clinical status of the patient, the possibilities in terms of service offerings available, financial constraints and optimization in terms of service reimbursements and their effectiveness.

In this context it desirable that the HCP knows the patient's emotional state during a talk with the patient, e.g. that the HCP knows about concerns about certain topics, in order to optimize the conversation and the provision of services and healthcare measures, e.g. to make sure that the patient follows a care plan and gets the right advises, where he is not too much concerned about and which potentially address the expressed concern. The average HCP sees many different patients and it is difficult for them to remember the emotional state (e.g. concerns, worries about lack of care or support) a patient might have had during the previous meeting.

Those needs do not only exist in the field of healthcare, but similar needs exist in other fields, e.g. in the field of psychology, job training, teaching, etc., in which the invention may also be applied for topic-related detection of the emotional state of a person.

WO 2013/088307 A1 discloses a history log of user's activities and associated emotional states. Data about a person's activity and about the person's emotional state during the activity is logged in a history log. The history log may serve as a diary to this person. The history log of one or more persons may serve as a reference-profile for generating recommendations.

### SUMMARY OF THE INVENTION

It is an object of the present invention to provide a system and method for unobtrusive topic-related detection of the emotional state of a person enabling that a user, e.g. a HCP, teacher or trainer, is provided with information about the person's emotional state in an unobtrusive way at the right time so that e.g. the user does not get distracted from the conversation itself.

It is a further object of the present invention to provide a corresponding processor, processing method and computer program for topic-related detection of the emotional state of a person.

In a first aspect of the present invention a system for unobtrusive topic-related detection of the emotional state of a person is presented, said system comprising
a data recorder for recording person-related data including one or more of video data, audio data, text data of the person,
a data analyzer for analyzing said person-related data to detect, at a given moment, the emotional state of the person and a topic dealt with by the person at the given moment, a topic representing a subject of conversation,
a storage unit for storing, for the person, topics dealt with by the person and the emotional state of the person associated with the one or more topics,
a retrieval unit for accessing said storage unit
   i) to check if it comprises an entry for a current topic that the person currently deals with and retrieve a stored emotional state of the person for the current topic and/or
   ii) to retrieve one or more topics, for which the storage unit comprises entries for the person with respect to one or more predetermined emotional states, and
a user interface for outputting
   i) the retrieved emotional state of the person and/or an emotional state indicator indicating the retrieved emotional state of the person for the current topic,
   ii) the retrieved one or more topics, for which the storage unit comprises entries for the person with respect to one or more predetermined emotional states and/or
   iii) one or more recommendations for a service or treatment to be provided to the person.

In a further aspect of the present invention a processor for unobtrusive topic-related detection of the emotional state of a person is presented, said processor comprising
a data analyzer for analyzing said person-related data including one or more of video data, audio data, text data of the person to detect, at a given moment, the emotional state of the person and a topic dealt with by the person at the given moment, a topic representing a subject of conversation,
a retrieval unit for accessing a storage unit storing, for the person, topics dealt with by the person and the emotional state of the person associated with the one or more topics
   i) to check if it comprises an entry for a current topic that the person currently deals with and retrieve a stored emotional state of the person for the current topic and/or
   ii) to retrieve one or more topics, for which the storage unit comprises entries for the person with respect to one or more predetermined emotional states, and
an output unit for outputting
   i) the retrieved emotional state of the person and/or an emotional state indicator indicating the retrieved emotional state of the person for the current topic,
   ii) the retrieved one or more topics, for which the storage unit comprises entries for the person with respect to one or more predetermined emotional states and/or
   iii) one or more recommendations for a service or treatment to be provided to the person.

In yet further aspects of the present invention, there are provided a computer program which comprises program code mans for causing a computer to perform the steps of the method disclosed herein when said computer program is carried out on a computer as well as a non-transitory computer-readable recording medium that stores therein a computer program product, which, when executed by a processor, causes the method disclosed herein to be performed.

Preferred embodiments of the invention are defined in the dependent claims. It shall be understood that the claimed methods, processor, computer program and medium have similar and/or identical preferred embodiments as the claimed system and as defined in the dependent claims.

The present invention is based on the idea to support the a user, e.g. a HCP, trainer or teacher, by detecting and providing unobtrusive information about the patient's emotional state, such as e.g. concerns, for instance during a talk between the person and the user (e.g. between a patient and the HCP). Knowing about the emotional state of the person is often important for two reasons, particularly in the field of healthcare:

i) Not remembering the patient's major concerns may damage the relationship with the patient. Vice versa, showing that the patient's major concerns are remembered can strengthen the relationship and build trust. As a consequence, the patient is more likely to follow the HCP's advice, which will improve adherence.
ii) Knowing the patient's concerns about a certain topic (e.g. a mentioned by the patient or the HCP; reflecting e.g. an issue or a need in the personal situation of the patient) will enable the HCP to try to recognize, acknowledge and address these concerns. Unaddressed concerns can lead to non-adherence and reduced medical outcomes.

In the context of the present invention a topic is a subject of conversation that is associated with a need or issue, for instance related to care, self-care or other problem related to health and daily activities. A concern is an emotional state meaning certain preset criteria that may be close to worry, displeasure or anxiety. This emotional state is associated with a conversation, text fragment or topic. A topic of concern is a topic with a selected emotional state (i.e. a concern) associated to it.

The present invention helps to achieve those advantages and avoid those disadvantages. There are generally two phases, an “encoding phase” and a “retrieval phase”.

In the “encoding phase”, during a conversation between person and user, e.g. between patient and HCP, the person-related data (video data, audio data and/or text data (including emoticons, pictures, pictograms)) are, preferably continuously, analyzed to detect the emotional state of the person, e.g. to detect the person's concerns. Further, the topic is dealt with by the person at the given moment is detected either continuously or only when a certain emotional state is detected, e.g. whenever concerns are detected. For instance, the speech from just before and just after the detected concern is used to detect the topic of the conversation. The detected topic is then stored in the list of topics related to a certain (detected emotional state), e.g. in a list of topics that the person is concerned about. The topics and the emotional state can generally be analyzed in parallel and in real-time (which is preferred), or subsequently in non-real-time.

In the “retrieval phase”, during a later conversation between person and user, e.g. whenever another face in the view of the HCP is detected, the entries regarding this person in the stored list are retrieved and used for one or more purposes to support the user. For instance, the list of topics that are stored in the list under concerns may be displayed to the user or the user may be signaled in some way if for a current topic there is particular entry in the list, e.g. a concern or a positive emotional state. Further, recommendations for services training and coaching or treatment (e.g. healthcare treatment, teaching, coaching, training, etc.) to be provided to the person may be given to the user based on the entries in the list. All this information about the person's emotional state given to the user in an unobtrusive way at the right time will help the user to better treat the person and address the person's needs.

Thus, for instance for use in the field of healthcare, the present invention enables capturing care needs and using background knowledge to provide real-time feedback to the HCP in terms of suggestions for either the modification of current services or a change in the service arrangement. The invention thus may help to support the HCP by providing timely suggestions for optimal service delivery during an interaction with the patient (either online communication or face-to-face).

It shall be noted that many details of the invention and many embodiments explained will refer to the field of healthcare and to conversations between patient and HCP. Since the invention can, however, also be used in other fields, all these references shall be understood as examples and can be equivalently applied in those other fields.

In an embodiment said system is configured to detect at least or only concerns as emotional state of the person. Concerns are particularly important since the lack of knowledge about concerns of a person, i.e. if the user does not know about concerns of the person, may lead to serious disadvantages as explained above.

In a further improvement said data analyzer is configured to detect at least or only when the person has concerns and to detect topics, for which it has been detected that the person has concerns, and i) wherein said storage unit is configured to store at least or only topics for which it has been detected that the person has concerns ii) wherein said retrieval unit is configured to check if for a current topic a concern has been detected at an earlier time and/or which topics are stored with respect to a concern of the person, and/or iii) wherein said user interface is configured to output at least or only an indication that the person had concerns with the current topic, if a corresponding entry has been retrieved from said storage unit, and/or the topics retrieved from the storage unit with respect to a concern of the person. Thus, various actions may be taken if concerns of the person with respect to a current topic are detected, depending on the desired implementation and use of the system.

Detecting a topic at an earlier time shall be understood as detecting the same topic again during the current interaction/conversation and/or as detecting the same topic again that has been detected during an earlier interaction/conversation. This may make a difference in the presentation and processing of the emotional states (e.g. concerns) detected. In particular, mentioning a topic more frequently during one interaction may indicate importance. Mentioning a topic in different interactions may signal that a concern has not been resolved. Both are important yet distinct findings.

Preferably, said data analyzer is configured to analyze the person-related data just before and just after a concern of the person has been detected to detect the topic with which the person has said concern. For instance, the speech of the person just before and just after a concern has been detected is analyzed. This saves processing time and power since at other times the current topic is not analyzed according to this embodiment.

In an embodiment the system further comprises a vital sign monitor for monitoring one or more vital signs of the person, wherein said data analyzer is configured to analyze said person-related data and/or said vital signs to detect, at a given moment, the emotional state of the person. Vital signs have shown to be an additional indicator for emotional state of the person and will thus further improve the reliability of the emotional state detection.

Advantageously, said data analyzer comprises a person recognition unit for identifying the person from said person-related data and optionally available vital signs. Thus, not only the detection of emotional states and topics can be automated, but also the detection of the person, to which the user is e.g. currently talking, is automated. Said information can then be used to check if there are any entries stored in the storage unit for this person.

In another embodiment said data analyzer comprises one or more of a facial expression recognition module, a gesture recognition module, a voice analysis module, a text analysis module a facial color detection module. Thus various options exist for detection of the emotional state, which depend on the desired implementation, available person-related data and application and on the desired accuracy of the result of the detection. Those modules as well as their function and their way of recognizing an emotional state from the processed data are generally known in the art and will not be explained herein in detail. Several modules may also be used in parallel, and their results may be weighted according to their reliability and/or accuracy of detection and/or the reliability and/or accuracy of the processed person-related data. One scenario may even be a conversation with deaf people (with a hearing impairment) who use sign language as their main means of expression so that even gesture or sign language recognition may be used in an embodiment for detecting an emotional state of a person.

Preferably, said data recorder comprises one or more of a camera, a microphone, a text receiving device, a speech-to-text converter. For instance, one or more of these elements may be built into a kind of glasses worn by the user during a conversation with the person (similar to Google Glass), into a smartphone or into a separate device worn by the user.

The system is preferably learning with time. Hence, in an embodiment said storage unit is configured to update the stored topics
based on the time since the topic was last dealt with and/or caused a predetermined emotional state,
after a predetermined event, in particular a conversation with the person,
by user interaction, and/or
if a different or no predetermined emotional state is detected when a topic, for which a predetermined emotional state is stored, is dealt with again.

In still another embodiment said user interface is configured to output an emotional state indicator indicating the retrieved emotional state of the person for the current topic and/or if the topic has caused a predetermined emotional state earlier in the form of a visual, audible and/or sensible (e.g. vibration) feedback signal, and/or comprises a display, a smartphone, a speaker, a light source or an actuator. The kind of implementation depends on the desired application, use by the user and costs of the device as well as the desirability to make the detected concern known to the person. Preferably, an unobtrusive feedback is provided, e.g. a sign on a display, such as a green sign indicating that the person has no concerns with the current topic or a red sign indicating that the person has concerns with the current topic.

Currently, the re-evaluation of the service offerings is done through interactions within a multi-disciplinary team. Based on (1) the clinical status, (2) a psycho-social assessment, (3) an inventory of services currently offered to the patient, (4) knowledge on the availability of services in the vicinity of the patient and (5) the financial constraints, care needs expressed during interactions (or manually entered by the HCP) are translated into recommendations for service offerings. The combination of these aspects typically occurs during multi-disciplinary meetings. The dialog with the patient on the possibilities of different/additional services will follow such meetings. Hence, in a further improvement the system further comprises a service selector for selecting a service, in particular a care or social service, to be provided to the person based the information retrieved by the retrieval unit from the storage unit and based on one or more of person's state data, the person's health data, person's psycho-social data, psychological assessments, living conditions, social network, service data about available services, historical personal data about earlier result of service selections for comparable persons and data. This helps the HCP to provide real-time feedback to the patient and therefore deliver care in a more efficient manner.

### BRIEF DESCRIPTION OF THE DRAWINGS

These and other aspects of the invention will be apparent from and elucidated with reference to the embodiment(s) described hereinafter. In the following drawings

FIG. 1 shows a schematic diagram of the general layout of a system according to the present invention,

FIG. 2 shows a schematic diagram of an embodiment of a method according to the present invention,

FIG. 3 shows a general diagram of emotions,

FIG. 4 shows a schematic diagram of an embodiment of a system according to the present invention, and

FIG. 5 shows a diagram illustrating various delivery forms of services.

### DETAILED DESCRIPTION OF THE INVENTION

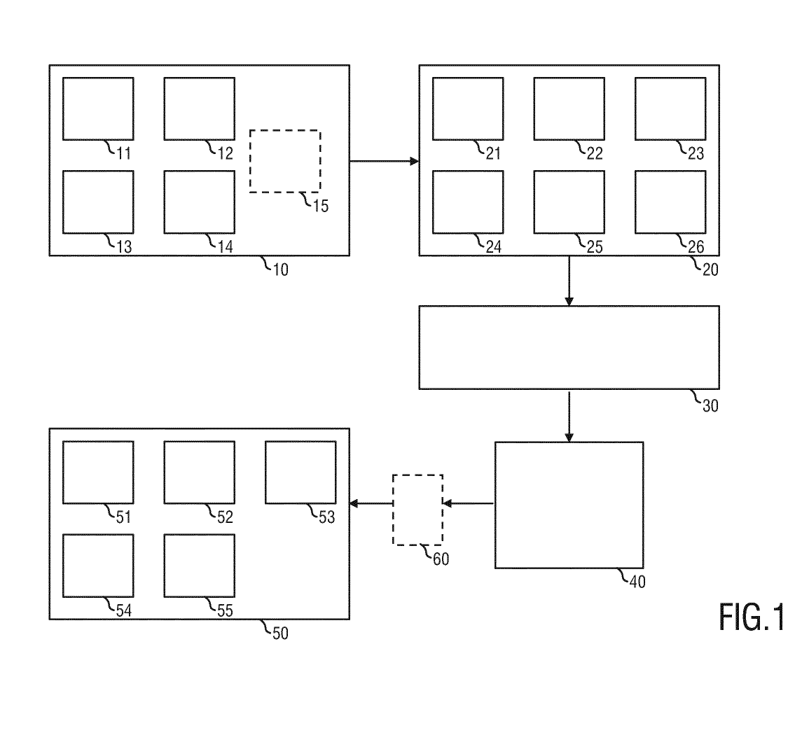

FIG. 1 shows a schematic diagram of the general layout of a system 1 for topic-related detection of the emotional state of a person according to the present invention. The system comprises a data recorder 10 for recording person-related data including one or more of video data, audio data, text data of the person (and/or third party related to the person, e.g. an informal care giver of the person). The data recorder 10 may comprise one or more of a camera 11 (e.g. a video camera), a microphone 12, a text receiving device 13 and a speech-to-text converter 14. Optionally, one or more vital sign monitor 15 for monitoring one or more vital signs (e.g. heart rate, breathing rate, blood pressure, SpO2, etc.) of the person (and/or any third party related to the person, e.g. an informal care giver) may be provided, said vital sign monitor comprising one or more separate sensor(s) or being configured to obtain such vital signs from camera images of the person, in particular of the person's skin, using a remote photoplethysmography technology as e.g. described in Verkruysse et al., “Remote plethysmographic imaging using ambient light”, Optics Express, 16(26), 22 Dec. 2008, pp. 21434-21445. Said vital signs may additionally be used as person-related data.

The system 1 further comprises a data analyzer 20 for analyzing said person-related data to detect, at a given moment, the emotional state of the person, e.g. concerns, disagreement, agreement, happiness, arousal, pleasure, etc. and a topic dealt with by the person at the given moment. For detecting the emotional state of the person the optionally available vital signs of the person may be, alone or in combination with other person-related data, used.

Preferably, the data analyzer 20 comprises a person recognition unit 21 for identifying the person from said person-related data and optionally available vital signs. Still further, for detecting the emotional state of the person and the current topic the data analyzer 20 preferably comprises one or more of a facial expression recognition module 22, a gesture recognition module 23, a voice analysis module 24, a text analysis module 25, a facial color detection module 26.

Emotions are typically operationalized using two dimensions: valence and arousal. Concerns are emotional states that fall into a low valence and medium to high arousal category. Using this conceptualization of concerns, they can be detected using facial expression analysis that is typically good at capturing very specifically the valence of a certain emotion with analyzing facial features (the most common approach is point tracking on the face and training a classifier on those point features) and somewhat good at capturing arousal. To do this, a classifier may be trained based on example data. The classifier can either be trained on one specific emotion (concerns; as reported by an expert emotion recognizer or the patient himself retrospectively), or on a more general negative affective state.

Using such a measurement, for each time slice (e.g. 1 second) a measure of level of concern or negative affective state of obtained. Then those parts of the session are taken, in which there was concern or negative affective state detected and process those parts as described above (i.e. extract a topic from the obtained data during that time).

A storage unit 30 is provided for storing, for the person, one or more topics dealt with by the person and the respective detected emotional state of the person, i.e. the detected emotional state of the person associated with the one or more (detected) topics. For instance, the storage unit may store a list of topics for which the person showed a particular emotional state, e.g. concerns. In a simple embodiment, in which there is only interest in topics for which the person showed one particular emotional state, e.g. concerns, the storage unit may only store those topics with respect to the person, but no other topics related to other emotional states.

Further, the system 1 comprises a retrieval unit 40 for accessing said storage unit 30 i) to check if it comprises an entry for a current topic that the person currently deals with and retrieve a stored emotional state of the person for the current topic and/or ii) to retrieve one or more topics, for which the storage unit comprises entries for the person with respect to one or more predetermined emotional states.

Finally, a user interface 50 is provided for outputting i) the retrieved emotional state of the person and/or an emotional state indicator indicating the retrieved emotional state of the person for the current topic, ii) the retrieved one or more topics, for which the storage unit comprises entries for the person with respect to one or more predetermined emotional states and/or iii) recommendations for services or treatment to be provided to the person. Said user interface (50) is preferably configured to output an emotional state indicator indicating the retrieved emotional state of the person for the current topic and/or if the topic has caused a predetermined emotional state earlier in the form of a visual, audible and/or sensible feedback signal. In a preferred embodiment the user interface 50 comprises a display 51 (e.g. on a handheld device or built into glasses worn by the user, such as Google Glass), a smartphone 52, a speaker 53, a light source 54, e.g. an LED, or an actuator 55, e.g. for providing a vibration.

The data analyzer 20, the retrieval unit 40 and an optional output unit 60, representing an interface between the retrieval unit 40 and the user interface 50, may be comprised in one or multiple digital or analog processors depending on how and where the invention is applied. The different units may completely or partly be implemented in software and carried out on a personal computer or processor. Some or all of the required functionality may also be implemented in hardware, e.g. in an application specific integrated circuit (ASIC) or in a field programmable gate array (FPGA).

In a practical exemplary implementation the system comprises
a wearable device (representing the data recorder 10) containing a camera, microphone, and semi-opaque display, and a wireless connectivity unit (e.g. similar to Google Glass);
a second device (representing part of the data analyzer 20 for emotional state detection) acting as a processor for the wearable device through a wireless connection to the wearable device and also containing a wireless connectivity unit, preferably providing internet connection;
a cloud based database (representing the storage unit 30) comprising a patient's electronic health record (EHR) and/or other information relevant to identify and address care needs, preferably enriched with topic-concerns entries;
a speech-to-text-to-topic converter (representing another part of the data analyzer 20 for topic detection);
a face recognition module for person identification; and
a facial expression recognition module (representing another part of the data analyzer 20 for emotional state detection).

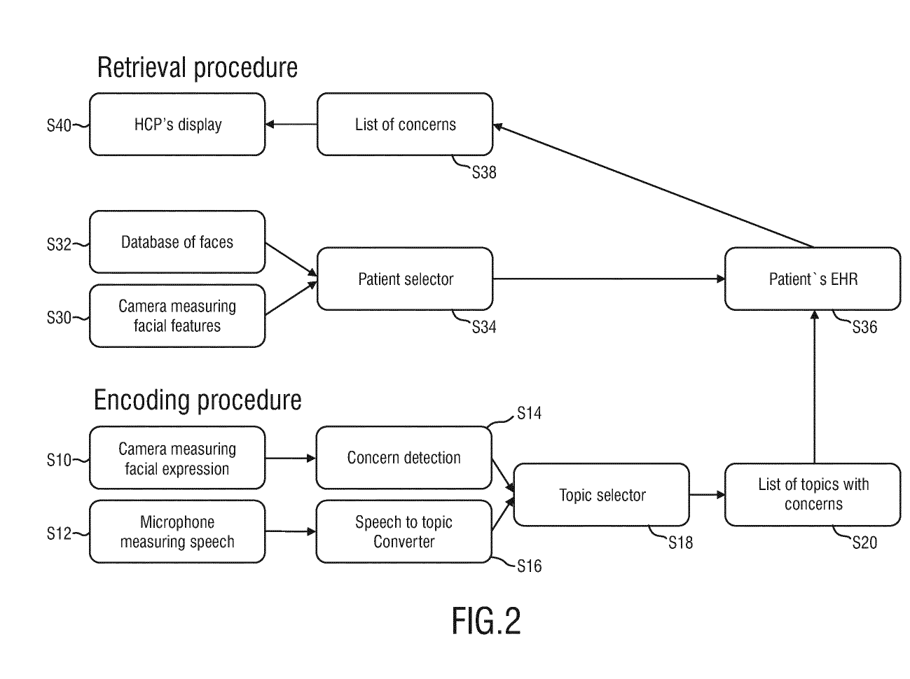

FIG. 2 shows a schematic diagram of an exemplary embodiment of a method according to the present invention. The method generally comprises an encoding phase and a retrieval phase.

In the encoding phase, particularly during a conversation of a HCP with a patient, images of the patient, in particular the patient's face, are acquired by a camera (S10) and speech of the patient is acquired by a microphone (S12). From the camera images the patient's facial expressions are continuously analyzed to detect concerns of the patient (S14). Whenever concerns are detected, the speech from just before and just after the detected concern is used to detect the topic of the conversation (S16, S18), and this topic is then stored in the list of topics that the patient is concerned about (S20).

In step S16 a text categorization or topic identification method is applied, which is generally a known technique in the field of natural language processing. It utilizes classification algorithms to identify the topic of a conversation, paragraph or sentence. When given a list of topics (or labels), the text fragment is classified by associating it with one or more topics by comparison with annotated example texts. This technique may be applied here in step S16 to identify the topic of conversation, e.g. “problems with washing”, “loneliness”, no transportation”, etc. In step S18, a topic is selected as a topic-of-concern, if the topic is associated with the current conversation (in step S16) and the topic is expressed during a passage in the appropriate emotional state.

In the retrieval phase, particularly during a conversation of a HCP with a patient, images of the patient, in particular the patient's face, are acquired by a camera (S30). Whenever the system detects face in the view of the HCP, the patient is identified (S32) by accessing a database of faces (S34). Thereafter, the system retrieves the corresponding patient entry in the list of topics, which is favorably included in the electronic health record (EHR) of the patient (S36). Particularly, the list of concerns is derived (S38) and the list of topics that are stored in the EHR under concerns is displayed (S40).

Thus, as described above, the proposed method consists of two phases. First, concerns are encoded during a conversation and subsequently retrieved during subsequent meeting using the system and method described above. Several detailed issues play a role, as will be explained below in more detail.

Emotional states (e.g. concerns) can fade away again. Hence, it is preferred to have a mechanism to remove topics from the list of concerns.

There are different options:
a. Topics can be removed based on time since recording, for instance every 6 months.
b. Topics can be removed after each subsequent conversation. This assumes that each emotional state (e.g. each concern) will be addressed during each conversation.
c. Topics can be removed from the list manually by the HCP, e.g. if they have been properly addressed (e.g. a problem has been solved by intervention in the form of service), if the person the patient has found a different coping strategy or if the HCP deems this to be of unimportance anymore (e.g., if the topic is “not being able to arrange meals”, then this maintains relevant until a solution is found or the HCP concludes that the patient is complaining for no good reason).
d. Whenever a topic with a particular previous emotional state (e.g. with concerns) is detected during the conversation, the system can measure the patient's response in his facial expressions. If, for instance, no concern is detected (or alternatively, if there is a positive expression detected), the topic of concern can be removed from the list.

Emotions do not have to be measured by facial expressions. Speech can also be used to measure emotions, or a combination of both can be used to get more accurate results. Further, text created by the patient (e.g. when interacting through chat sessions or e-mail), including emoticons, images and other methods to enrich online text and give it more emotional content, can also be used.

The topics can be encoded on different levels. On a high level, topics can be as basic as the disease medication social support life expectancy, etc. In one implementation this list can be used to compare the speech-to-topic conversion against and select the topic that is closest (or none, if none is close enough). In another implementation, topics can be the direct result of a general speech-to-topic convertor. To help the HCP understand exactly what the topic was, next to a few keywords the actual relevant part of the speech can be saved in the EHR can be saved as well, so that the HCP can listen back to it.

A potential extension is to also store a value for the severity of the detected emotional state, e.g. concern (based e.g. on the facial expression measurements). This can subsequently be used to retrieve only topics that had a certain level of severity, or to order the topics based on severity so that the HCP can decide which topics are most important to address if there is not enough time for all the emotional states, e.g. concerns.

The system and method according to the present invention can also be extended to not only include concerns but also positive emotional states, as these can be used to build a pleasant atmosphere during the conversation and build rapport. In the system, each emotional state can be represented by a separate list of topics. The granularity of the different emotional states can be adjusted (e.g., only positive-negative; or e.g. differentiating between sadness, anger, fear, or relaxation, happiness, elation).

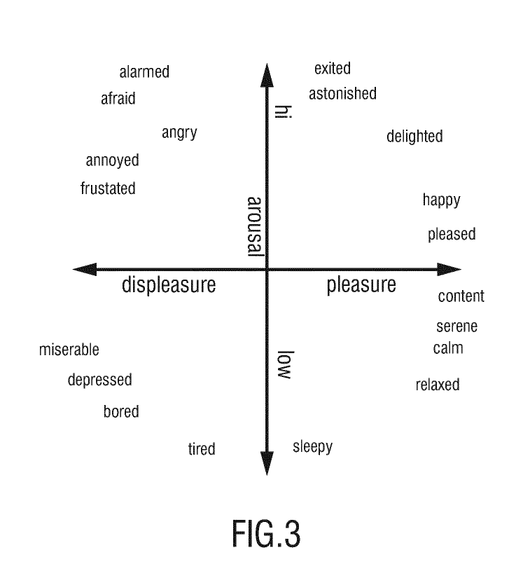

The automatic detection of emotion through physiological parameters and voice analysis is typically done by quantifying the state of the person over two dimensions: valence and arousal. Using these two axes, emotions like “angry”, “excited” or “bored” can be expressed. For example, angry is associated with high arousal and negative valance levels as illustrated in the diagram shown in FIG. 3.

When detecting emotions through physiology or audio analysis, one or both of these dimensions are captured to classify the state of the person. When using a different means of capturing emotions, e.g. through text analysis or facial expression recognition, then the detection of emotions is generally a classification problem. A pre-defined number of labels (“sad”, “happy”, “aroused”) is used to classify a fragment of audio/video/text. This classifier can return a single label, no label or a combination of labels with their likelihood. When using the emotional state in the proposed system and method, it is envisioned to use a predefined threshold to determine whether the emotional state is of significance. For example, when using the valance/arousal model, a threshold can be defined solely on the arousal of the subject. When applying a classifier, in an example case, a threshold determines that each state other than “happy” or “neutral” is of importance.

Further, settings of the system can optionally be adjusted by the HCP. For instance, types of topics that are taken into account, threshold for the severity of the concern, memory management, usability parameters like time between visits.

Several possibilities for real time feedback for the HCP and the patient can be included. One option is unobtrusive feedback to the HCP whenever a concern is detected. This could be through a small vibration in the chair or through the phone of the HCP. Another form of feedback might be through subtle light changes that can calm the patient when concerned and can indicate to the HCP that there is a concern to the patient, both at the same time. This light setting can also help the HCP to remember the concern better. Finally, there could be physical display of the patient's emotions or concerns by an avatar, to make it easier for the HCP to understand what the patient is going through.

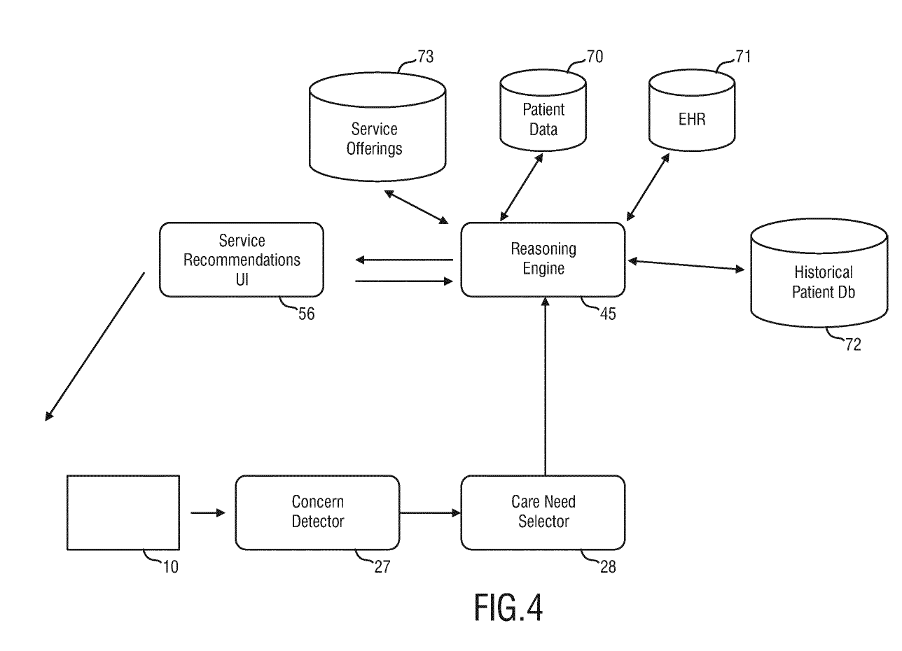

FIG. 4 shows a schematic diagram of an embodiment of a system 2 according to the present invention. Elements of the system 1 shown in FIG. 1 are given the same reference number. The conversation between HCP, patient and/or informal care giver is captured by a data recorder 10 for recording audio, video and/or textual material. Optionally, vital signs of the patient and/or informal care giver may be recorded as well. During this conversation, concerns about life, well-being and treatment are captured by a concern detector 27 (representing an embodiment of part of the data analyzer 20 for analyzing the patient's emotional state) and subsequently the topic of discussion is identified by the concern detector 27.

The care need selector 28 (representing an embodiment of part of the data analyzer 20 for detecting the current topic) determines the current topic and care needs.

The reasoning engine 45 (also called service selector) utilizes the identified topic to recommend an update of the patient's service arrangement. This update is combined by profiling the patient's current state as recorded in a patient data database 70 and the EHR 71 (in particular psycho-social, clinical, financial state, current service offerings and current resource utilizations). This profile and the topic are compared with patients with similar profiles from a historic database 72, leading to a list of service options. This list of service options is finally matched with the services available for the patient (based on location, insurance and other constraints) as provided in a service offerings database 73. Based on this process, recommendations for a rearrangement of services are presented to the HCP via a service recommendations user interface (UI) 56 (representing an embodiment of the user interface 50). Using an interaction mechanism, the HCP can discuss options with the patient and indicate which services are acceptable and which not. Using this immediate feedback alternative options are presented. Generally, each moment a new care need is detected, all information in the system 2 is matched to derive an update of the recommended service arrangement.

In the following the individual components will be explained in detail.

The concern detector 27 is one embodiment of part of the data analyzer 20 and has been described in detail above. Several options may be used (separately or in combination):

a) Through the facial expression analysis as described above.
b) Through voice analysis. The voice of the patient is identified by learning algorithms, based on the voice of the HCP. Subsequently, through known emotional analysis algorithms, the parts of the conversation are identified where the patient or care giver raises a concern. These algorithms can be used in face-to-face as well as in online meetings.
c) Through text analysis (including e.g. emoticons, pictures, pictograms, etc.), in the case of a chat or e-mail conversation. Using known sentiment analysis algorithms, textual elements are extracted that signal a patient's concern.

Subsequently, the care need selector 28 (representing an embodiment of part of the data analyzer 20) utilizes the extracted fragment (text or audio) and matches this with a predetermined finite list of topics. Alternatively, the care need is selected within a list presented to the HCP.

The EHR database 71 describes the latest clinical status of the patient, including demographics, insurance plan, disease codes, diagnostics, disease progression and resources utilized. Among the resources, a detailed list of current services and their delivery form is listed. It is assumed that each service offered to the patient has one or more delivery form.

The additional patient data database 70 describes non-clinical details on the patient, including living arrangements, social support from family, neighbors and friends and the psychological profile of the patient and their carer. For the patient and a collection of zero or more informal carers (partner, family, neighbors, friends, the priest) their motivation and influence on each other, self-efficacy, their personality and well as depression and anxiety status are modeled. Also listed is the services received by informal care givers, e.g. meal support by a neighbor or help in gardening by a daughter. The tasks are split out into different categories: practical tasks (e.g. gardening), personal/intimate tasks (e.g. bathing), patient advocacy, signaling, support for emotional coping with the condition and motivating the patient for better self-care.

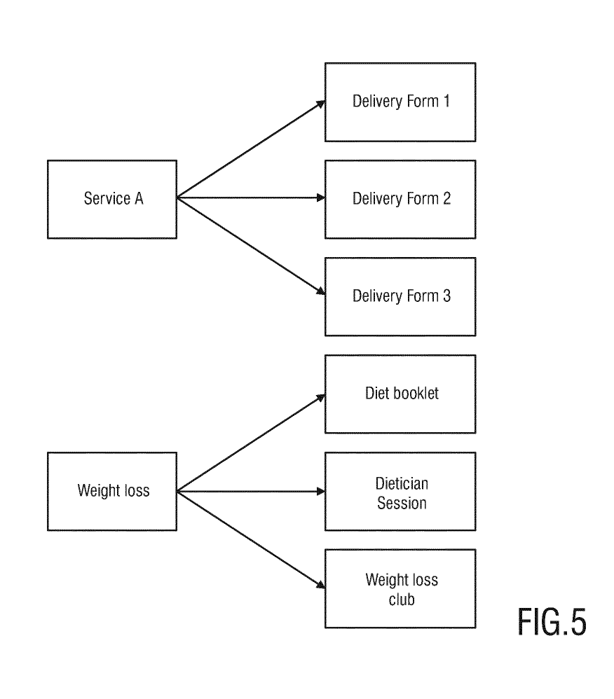

The service offerings database 73 is a general database for the healthcare organization describing all possible service offerings and their delivery form. For each service for each delivery form, this database specifies the benefit of the service, the cost, the conditions for the offering in terms of patient profile and availability constraints (e.g. based on postal code). Each service and each delivery form is annotated with the care need it addresses. This is illustrated in FIG. 5. A service can address multiple care needs, and one care need can be addressed by a plurality of services and delivery forms of services. Also, an effectiveness indicator expressing quality or effectiveness of the intervention can be provided. For example, a personal health coach may receive a higher effectiveness score than a booklet on dieting.

The historical patient database 72 is a resource describing details from all current and past patients. These details include the status in the EHR, the additional patient data, the services and the delivery forms offered to the patient and the care needs that are detected for the individual patients.

The reasoning engine 45 provides recommendations on the services and their delivery form for the patient. Various options exist for the reasoning engine 45:

i) A list of care needs for the patient is derived using the EHR, where disease codes, laboratory results and other clinical values are translated into care needs using a look-up table. For example, for a heart failure diagnosis with NYHA class IV, the care need care_for_Heart_Failure_IV can be identified. In the service offerings database, this care need may be associated with services like home nurse visits or even palliative care.
ii) The list of care needs is further enriched with care needs derived from the additional patient database. This database comprises elements describing the nursing assessment and other psycho-social aspects related to the patient's health, wellness and ability to self-care. For example the care need “meal_support” may be derived by combining the facts “frail” and “lives alone” in the additional patient database. This database only contains the care needs detected during previous meetings.
iii) If a new care need is detected, it is matched with the service offerings database. The available services and their delivery options are pre-selected by matching the annotated care needs with the known care needs of the patient plus the new care need identified. This step results in a list of all possibly relevant service offerings for the combination of care needs.
iv) From the list of service offerings, a selection is made as recommendation for the patient. This selection is created using the current list of services offered to the patient. Given the difference in care needs the combination of services is recommended with the smallest difference to the current offering. In this selection, a combination of services is selected where all care needs are addressed by one or more services. When considering an arrangement of services, the following actions may be taken:
a) The availability of each service for the patient is evaluated; services that are not available are removed from the list of candidate services.
b) The financial budget for the patient is used as constraint in the local search algorithm to select the appropriate services. No service arrangements are suggested that do not fit the financial constraints.
c) If multiple service arrangements fit within the financial constraints of the patient, then the service arrangement is recommended with the highest effectiveness score. This effectiveness score is computed using a weighted sum of all individual services. The weights are predetermined and can be based on the cost of the service.
d) The list of recommended services is presented to the HCP, where the changes from the current service selection is highlighted

The service recommendation user interface 56 can prioritize care needs in order to tweak service offerings that make most impact. The service recommendation user interface 56 can be used by the HCP for two purposes:

1. Recommended services can be rejected. In a discussion with the patient, not all suitable services may be acceptable. In this case, the HCP can highlight a service from the list of recommendations as undesirable. This action triggers a re-computation of the service offerings, without the de-selected service.
2. Care needs as captured by the system can be de-selected or overruled. The list of captured care needs is presented to the HCP. Some of the care needs identified in the records may be outdated or less of an issue. In such a case, a care need can be flagged. The list of recommended services is subsequently re-computed based on the updated list of care needs.
3. If a service is proposed to the patient, the same mechanism is used to detect the patient's response. If they are negative about the service, or mentioning the service triggers additional concerns, this feedback is captured to recompute the service recommendations.

The present invention can favorably be applied in the field of readmission management or Hospital to Home care, which aims at delivering high quality, cost effective care throughout the care continuum. By pro-actively scouting for the onset of new diseases, the worsening of the patient's condition may be prevented.

While the invention has been illustrated and described in detail in the drawings and foregoing description such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage unit medium or a solid-state medium supplied together with or as part of other hardware, but may also be distributed in other forms, such as via the Internet or other wired or wireless telecommunication systems.

Any reference signs in the claims should not be construed as limiting the scope.

1. A system for topic-related detection of the emotional state of a person, the system comprising:
a data recorder for recording person-related data including one or more of video data, audio data, text data of the person,
a data analyzer for analyzing said person-related data to detect, at a given moment, the emotional state of the person and a topic dealt with by the person at the given moment, a topic representing a subject of conversation,
a storage unit for storing, for the person, one or more topics dealt with by the person and the emotional state of the person associated with the one or more topics,
a retrieval unit for accessing said storage unit
i) to check if it comprises an entry for a current topic that the person currently deals with and retrieve a stored emotional state of the person for the current topic, and/or
ii) to retrieve one or more topics for which the storage unit comprises entries for the person with respect to one or more predetermined emotional states, and
a user interface for outputting
i) the retrieved emotional state of the person and/or an emotional state indicator indicating the retrieved emotional state of the person for the current topic, and/or
ii) the retrieved one or more topics, for which the storage unit comprises entries for the person with respect to one or more predetermined emotional states, and/or
iii) one or more recommendations for a service or treatment to be provided to the person.

2. The system claimed in claim 1,
wherein said system is configured to detect at least or only concerns as emotional state of the person.

3. The system claimed in claim 2,
wherein said data analyzer is configured to detect at least or only when the person has concerns and to detect topics, for which it has been detected that the person has concerns,
wherein said storage unit is configured to store at least or only topics, for which it has been detected that the person has concerns,
wherein said retrieval unit is configured to check if for a current topic a concern has been detected at an earlier time and/or which topics are stored with respect to a concern of the person, and/or
wherein said user interface is configured to output at least or only an indication that the person had concerns with the current topic, if a corresponding entry has been retrieved from said storage unit, and/or the topics retrieved from the storage unit with respect to a concern of the person.

4. The system claimed in claim 1,
wherein said data analyzer is configured to analyze the person-related data just before and just after a concern of the person has been detected to detect the topic with which the person has said concern.

5. The system claimed in claim 1,
further comprising a vital sign monitor for monitoring one or more vital signs of the person,
wherein said data analyzer is configured to analyze said person-related data and/or said vital signs to detect, at a given moment, the emotional state of the person.

6. The system claimed in claim 1,
wherein said data analyzer comprises a person recognition unit for identifying the person from said person-related data and optionally available vital signs.

7. The system claimed in claim 1,
wherein said data analyzer comprises one or more of a facial expression recognition module, a gesture recognition module, a voice analysis module, a text analysis module, a facial color detection module.

8. The system claimed in claim 1,
wherein said data recorder comprises one or more of a camera, a microphone, a text receiving device, a speech-to-text converter.

9. The system claimed in claim 1,
wherein said storage unit is configured to update the stored topics
based on the time since the topic was last dealt with and/or caused a predetermined emotional state,
after a predetermined event, in particular a conversation with the person,
by user interaction, and/or
if a different or no predetermined emotional state is detected when a topic, for which a predetermined emotional state is stored, is dealt with again.

10. The system claimed in claim 1,
wherein said user interface is configured to output an emotional state indicator indicating the retrieved emotional state of the person for the current topic and/or if the topic has caused a predetermined emotional state earlier in the form of a visual, audible and/or sensible feedback signal, and/or comprises a display, a smartphone, a speaker, a light source or an actuator.

11. The system claimed in claim 1,
further comprising a service selector for selecting a service, in particular a care or social service, to be provided to the person based the information retrieved by the retrieval unit from the storage unit and based on one or more of person's state data, the person's health data, person's psycho-social data, psychological assessments, living conditions, social network, service data about available services, historical personal data about earlier result of service selections for comparable persons and data.

12. A method for topic-related detection of the emotional state of a person, the method comprising:
recording person-related data including one or more of video data, audio data, text data of the person,
analyzing said person-related data to detect, at a given moment, the emotional state of the person and a topic dealt with by the person at the given moment, a topic representing a subject of conversation,
storing, for the person, one or more topics dealt with by the person and the emotional state of the person associated with the one or more topics in a storage unit,
accessing said storage unit
i) to check if it comprises an entry for a current topic that the person currently deals with and retrieve a stored emotional state of the person for the current topic, and/or
ii) to retrieve one or more topics for which the storage unit comprises entries for the person with respect to one or more predetermined emotional states, and
outputting
i) the retrieved emotional state of the person and/or an emotional state indicator indicating the retrieved emotional state of the person for the current topic, and/or
ii) the retrieved one or more topics, for which the storage unit comprises entries for the person with respect to one or more predetermined emotional states, and/or
iii) one or more recommendations for a service or treatment to be provided to the person.

13. A processor for topic-related detection of the emotional state of a person, the processor comprising:
a data analyzer for analyzing person-related data including one or more of video data, audio data, text data of the person to detect, at a given moment, the emotional state of the person and a topic dealt with by the person at the given moment, a topic representing a subject of conversation,
a retrieval unit for accessing a storage unit storing, for the person, one or more topics dealt with by the person and the emotional state of the person associated with the one or more topics,
i) to check if it comprises an entry for a current topic that the person currently deals with and retrieve a stored emotional state of the person for the current topic and/or
ii) to retrieve one or more topics, for which the storage unit comprises entries for the person with respect to one or more predetermined emotional states, and
an output unit for outputting
i) the retrieved emotional state of the person and/or an emotional state indicator indicating the retrieved emotional state of the person for the current topic,
ii) the retrieved one or more topics, for which the storage unit comprises entries for the person with respect to one or more predetermined emotional states and/or
iii) one or more recommendations for a service or treatment to be provided to the person.

14. A processing method for topic-related detection of the emotional state of a person, the processing method comprising:
analyzing person-related data including one or more of video data, audio data, text data of the person to detect, at a given moment, the emotional state of the person and a topic dealt with by the person at the given moment, a topic representing a subject of conversation,
accessing a storage unit storing, for the person, one or more topics dealt with by the person and the emotional state of the person associated with the one or more topics
i) to check if it comprises an entry for a current topic that the person currently deals with and retrieve a stored emotional state of the person for the current topic and/or
ii) to retrieve one or more topics, for which the storage unit comprises entries for the person with respect to one or more predetermined emotional states, and
outputting
i) the retrieved emotional state of the person and/or an emotional state indicator indicating the retrieved emotional state of the person for the current topic,
ii) the retrieved one or more topics, for which the storage unit comprises entries for the person with respect to one or more predetermined emotional states and/or
iii) one or more recommendations for a service or treatment to be provided to the person.

15. Computer program comprising program code means for causing a computer to carry out the steps of the processing method as claimed in claim 14 when said computer program is carried out on the computer.
